(19) United States
(12) Patent Application Publication
(10) Pub. No.: US 2024/0061192 A1
(43) Pub. Date: Feb. 22, 2024

(54) FIBER ARRAY UNIT (FAU) DESIGNS TO ENABLE A HIGHER IO BANDWIDTH PER UNIT LENGTH AND HIGHER FIBER DENSITY

(71) Applicant: Intel Corporation, Santa Clara, CA (US)

(72) Inventors: Chia-Pin CHIU, Tempe, AZ (US); Finian ROGERS, Newbridge (IR); Tim Tri HOANG, San Jose, CA (US); Kaveh HOSSEINI, Livermore, CA (US); Omkar KARHADE, Chandler, AZ (US)

(21) Appl. No.: 17/889,233

(22) Filed: Aug. 16, 2022

(51) Int. Cl. G02B 6/42

(52) U.S. Cl. CPC G02B 6/425; G02B 6/4243

(57) ABSTRACT

Embodiments disclosed herein include electronic packages and methods of forming electronic packages. In an embodiment, the electronic package comprises a package substrate, a die coupled to the package substrate, a photonics integrated circuit (PIC) coupled to the die, and a fiber array unit (FAU) optically coupled to the PIC. In an embodiment, the FAU has a base with a first width and a protrusion with a second width that is smaller than the first width.

### GOVERNMENT LICENSE RIGHTS

This invention was made with Government support under Agreement No. HR00111830002, awarded by the United States Department of Defense. The Government has certain rights in the invention.

### TECHNICAL FIELD

Embodiments of the present disclosure relate to optoelectronic packages, and more particularly to fiber array units (FAUs) with designs in order to enable higher IO bandwidth per unit length and higher fiber density.

### BACKGROUND

As XPU (e.g., FPGA, CPU, GPU, VPU, etc.) integrate electronic systems with photonics integrated circuits (PICs) to achieve ultra-low power and ultra-high bandwidth systems, the challenge of assembling the systems is increased. Currently, fragile fiber array unit (FAU) components are handled with tweezers. The placements of the PIC and the FAU are usually constrained by the tweezer (or gripper) size of the assembly tool. The assembly tool holds the FAU at an aligned position with respect to the PIC (active alignment) until the optical epoxy is deposited and UV cured. The tweezer arm is typically 1-2 mm wide. An addition 0.5 mm is typically needed in order to maneuver the tweezer freely between the FAUs during the alignment process. As such, a minimum spacing between FAUs may be between 1.5 mm and 2.5 mm in some instances. However, the large spacing between FAUs results in a decrease in the fiber density per unit length in the Y-direction. Accordingly, optimal shoreline density, as measured by I/O per unit length, and fiber density are diminished by existing assembly processes.

### BRIEF DESCRIPTION OF THE DRAWINGS

FIG. 1A is a plan view illustration of an electronic package that includes fiber array units (FAUs) that are spaced at a distance to allow the tweezer to maneuver freely, in accordance with an embodiment.

FIG. 1B is a plan view illustration of an electronic package that includes FAUs at a reduced spacing, in accordance with an embodiment.

FIG. 1C is a plan view illustration of the electronic package that includes FAUs at a reduced spacing where the tweezer cannot fit between the FAUs, in accordance with an embodiment.

FIG. 2 is a perspective view illustration of an electronic package that includes FAUs that have T-shaped cross-sections, in accordance with an embodiment.

FIG. 3A is a perspective view illustration of an electronic package where a first FAU is coupled to a first PIC, in accordance with an embodiment.

FIG. 3B is a perspective view illustration of the electronic package where a third FAU is coupled to a third PIC, in accordance with an embodiment.

FIG. 3C is a perspective view illustration of the electronic package where a second FAU with a T-shaped cross-section is coupled to a second PIC between the first FAU and the third FAU, in accordance with an embodiment.

FIG. 3D is a perspective view illustration of an electronic package with four FAUs with a second FAU and a fourth FAU that comprise T-shaped cross-sections, in accordance with an embodiment.

FIG. 4A is a perspective view illustration of an electronic package where a first FAU is coupled to a first PIC, in accordance with an embodiment.

FIG. 4B is a perspective view illustration of the electronic package where a third FAU is coupled to a third PIC, in accordance with an embodiment.

FIG. 4C is a perspective view illustration of the electronic package where a second FAU is coupled to a second PIC, wherein the second FAU is taller than the first and third FAUs, in accordance with an embodiment.

FIG. 4D is a perspective view illustration of the electronic package with four FAUs, where the second and fourth FAUs are taller than the first and third FAUs, in accordance with an embodiment.

FIG. 5 is a series of illustrations depicting an FAU that is coupled to a PIC using a grating coupler, in accordance with an embodiment.

FIG. 6 is a series of illustrations depicting an FAU that is edge coupled to a waveguide at a top of the PIC, in accordance with an embodiment.

FIG. 7 is a series of illustrations depicting an FAU that is edge coupled to a waveguide at a bottom of the PIC, in accordance with an embodiment.

FIG. 8A is a perspective view illustration of an electronic package with an FAU inserted in a cutout in the package substrate, in accordance with an embodiment.

FIG. 8B is a perspective view illustration of the electronic package after the FAU is coupled to a PIC, in accordance with an embodiment.

FIG. 8C is a perspective view illustration of an electronic package with an opening in the package substrate that is too small to accommodate the tweezers, in accordance with an embodiment.

FIG. 8D is a perspective view illustration of an electronic package with a reduced size opening in the package substrate and an FAU with a T-shaped cross-section, in accordance with an embodiment.

FIG. 8E is a perspective view illustration of the electronic package after the T-shaped FAU is coupled to the PIC, in accordance with an embodiment.

FIGS. 9A-9J are perspective view illustrations of FAUs that include portions with a T-shaped cross-section, in accordance with various embodiments.

FIG. 10 is a schematic of a computing device built in accordance with an embodiment.

### EMBODIMENTS OF THE PRESENT DISCLOSURE

Described herein are fiber array units (FAUs) with designs in order to enable higher IO bandwidth per unit length and higher fiber density, in accordance with various embodiments. In the following description, various aspects of the illustrative implementations will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative implementations. However, it will be apparent to one skilled in the art that the present invention may be practiced without the specific details. In other instances, well-known features are omitted or simplified in order not to obscure the illustrative implementations.

Various operations will be described as multiple discrete operations, in turn, in a manner that is most helpful in understanding the present invention, however, the order of description should not be construed to imply that these operations are necessarily order dependent. In particular, these operations need not be performed in the order of presentation.

As noted above, the ability to reduce the spacing between fiber array units (FAUs) in electronic packages is limited by the size of tweezers used to couple the FAUs to photonics integrated circuits (PICs). Particularly, the spacing between the FAUs needs to accommodate the width of the tweezer (e.g., 1-2 mm) and a buffer (e.g., 0.5 mm) to allow for the tweezers to move in order to implement active alignment between the FAUs and the PICs.

Accordingly, embodiments disclosed herein include FAU architectures and assembly methods that allow for a reduction in the spacing between FAUs. Particularly, embodiments include FAUs that include a T-shaped cross-section. The base may have the width of a standard FAU, and a protrusion up from the base may have a reduced width. The tweezers can grip the FAU by the protrusion instead of the base. Since the protrusions have a reduced width, there is more room to fit and maneuver the tweezers. As such, the spacing between FAUs can be decreased and the fiber density per unit length can be increased. For example, a spacing between FAUs may be approximately 100 μm or less. This allows for a higher bandwidth for the electronic package.

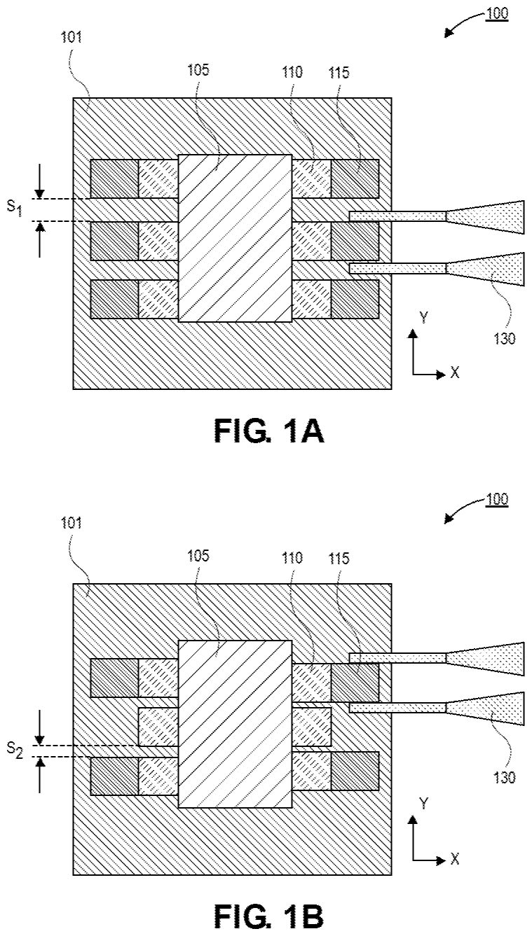

In order to provide context, FIGS. 1A-1C are shown to illustrate the problem of needing to accommodate the tweezers. In FIG. 1A, a plan view illustration of an electronic package 100 is shown, in accordance with an embodiment. The electronic package 100 may include a package substrate 101, such as an organic package substrate. A die 105 may be provided on the package substrate. The die 105 may be an electrical die, and can be any type of die (e.g., CPU, GPU, FPGA, VPU, or the like). The die 105 may operate in the electrical regime. In an embodiment, a plurality of PICs 110 may be coupled to the die 105. The PICs 110 may convert an optical signal into an electrical signal, or convert and electrical signal into an optical signal. That is, the PICs 110 allow for an electrical die 105 to communicate with external components using optical signaling architectures.

In an embodiment, FAUs 115 may be coupled to each of the PICs 110. The FAUs 115 may provide coupling between the PIC 110 and optical fibers (not shown). That is, the FAUs 115 may be mechanical structures that hold optical fibers in a proper alignment with the PICs 110. As shown, the spacing S₁ between the FAUs 115 needs to be wide enough to accommodate tweezers 130 that grip the edges of the FAUs 115. For example, the spacing S₁ may be between 1.0 mm and 3.0 mm in some instances. Such a relatively large spacing reduces the fiber per unit length density.

Referring now to FIG. 1B, a plan view illustration of another electronic package 100 is shown, in accordance with an embodiment. As shown, the spacing S₂ between PICs 110 and FAUs 115 is reduced compared to the embodiment shown in FIG. 1A. In such an embodiment, a first FAU 115 (i.e., bottom row) and a third FAU 115 (i.e., top row) can be coupled to the corresponding PICs 110 without issue. However, as shown in FIG. 1C, as the tweezers 130 bring the middle FAU 115 into the electronic package 100, there is no room to accommodate the tweezers 130. As such, the electronic package cannot be fully assembled. No matter what order the FAUs 115 are coupled to the electronic package 100, there will be issues with accommodating the tweezers. This results in the need for a structure similar to the structure shown in FIG. 1A that includes wide spacings between the FAUs 115.

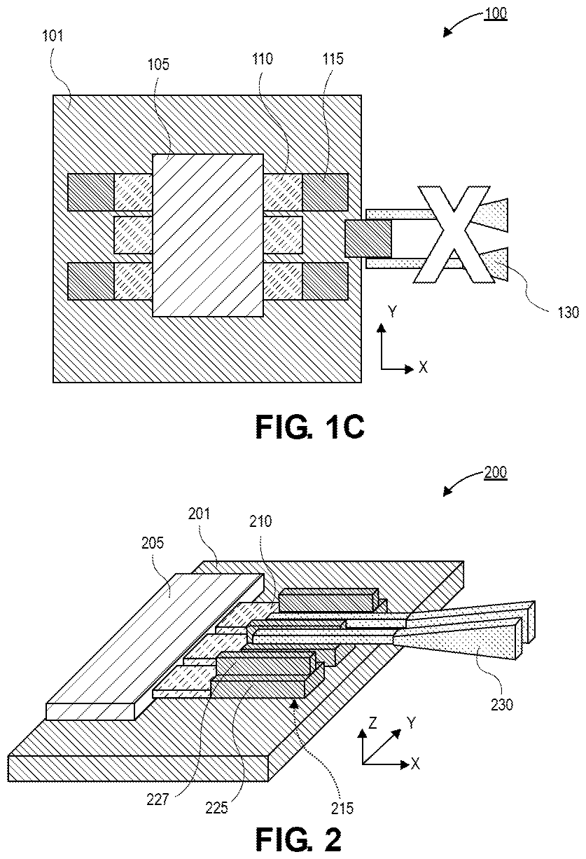

Accordingly, embodiments disclosed herein include FAUs with unique structures that enable reduced spacing between the FAUs. An example of such an embodiment is shown in FIG. 2. FIG. 2 is a perspective view illustration of an electronic package 200 that includes FAUs 215 that include a T-shaped cross-section.

In an embodiment, the electronic package 200 may comprise a package substrate 201. A die 205 may be provided on the package substrate 201. The die 205 and the package substrate 201 may be substantially similar to the die 105 and the package substrate 101 described in greater detail above. In an embodiment, a plurality of PICs 210 may be coupled to the die 205. In an embodiment, a plurality of FAUs 215 may be optically coupled to the PICs 210. As used herein, optically coupling the FAU to a PIC or an FAU that is optically coupled to a PIC, may refer to one or more optical fibers housed by the FAU 215 being in optical communication with the PIC. That is, optical signals generated by the PIC are able to be propagated along one or more optical fibers of the FAU, or an optical signal propagated along one or more optical fibers of the FAU can be delivered to the PIC.

In an embodiment, each FAU 215 may include a base 225 and a protrusion 227. The base 225 may have a first width, and the protrusion 227 may have a second width that is smaller than the first width. In an embodiment, second width may be chosen to accommodate tweezers 230 used to couple the FAUs 215 to the PICs 210. For example, when each arm of the tweezers 230 has a width that is approximately 2.0 mm, the second width may be smaller than the first width by approximately 4.0 mm or more. As used herein, “approximately” may refer to a range of values within 10% of the stated value. For example, approximately 2.0 mm may refer to a range of values between 1.8 mm and 2.2 mm. In an embodiment, the protrusion 227 may be centered on the base 225. In an embodiment, the bases 225 of the FAUs 215 may be spaced away from each other by a spacing that is approximately 100 μm or less. In an embodiment, the base 225 may be taller than the PIC 210.

In the illustrated embodiment, the T-shaped cross-section is an upside down T. Though, in other embodiments described in greater detail below, the T-shaped cross-section may be oriented in the opposite direction. In FIG. 2, the T-shaped cross-section is in the Y-Z plane. In other embodiments, the T-shaped cross-section may be in the X-Y plane, as will be described in greater detail below. Additionally, the FAUs 215 have a uniform cross-section through all Y-Z planes. Though, in other embodiments, this might not be the case. Furthermore, all of the FAUs 215 in FIG. 2 include the T-shaped cross-section. However, in other embodiments, every other FAU 215 may have the T-shaped cross-section.

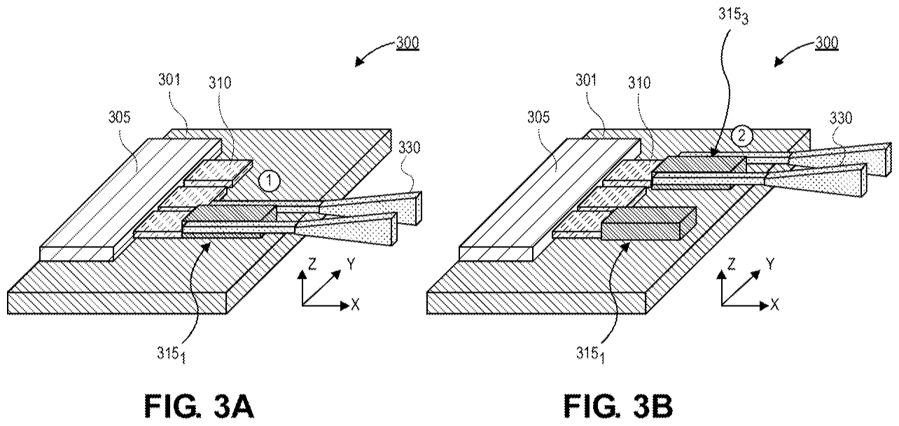

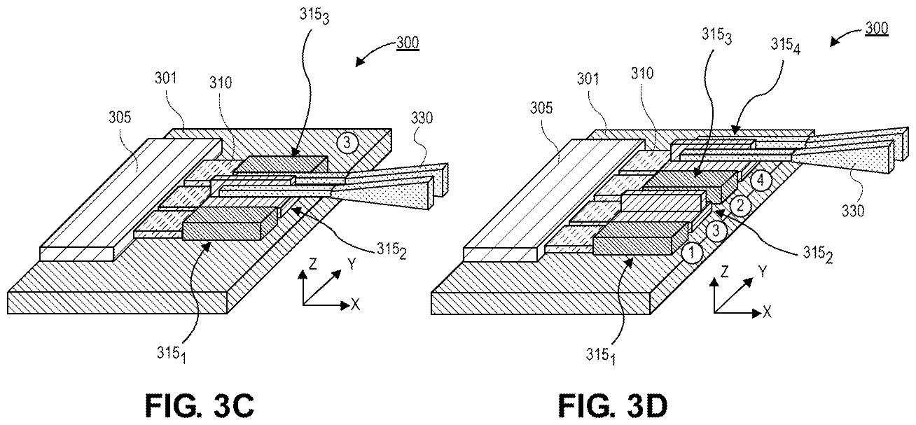

For examples, FIGS. 3A-3D provide a process flow that illustrates how standard FAUs 315 can be integrated with T-shaped cross-section FAUs 315 in order to provide electronic packages 300 with FAUs with tight spacings. In FIG. 3A, the electronic package 300 comprises a package substrate 301, a die 305, and PICs 310. The package substrate 301, the die 305, and the PICs 310 may be similar to any of the embodiments described in greater detail above. As shown, tweezers 330 may couple a first FAU 315₁ to a first PIC 310. Since there are no other FAUs 315 in the way, the placement of the first FAU 315₁ is simple. The first FAU 315₁ may be a standard FAU structure. That is, the first FAU 315₁ may only include the base with no extending or protruding portions.

Referring now to FIG. 3B, a perspective view illustration of the electronic package after a third FAU 315₃ is coupled to a third PIC 310 using tweezers 330 is shown, in accordance with an embodiment. In an embodiment, the third FAU 315₃ may also be a standard FAU 315 without a T-shaped cross-section. Since the third FAU 315₃ and the first FAU 315₁ are separated by the middle PIC 310, there is still plenty of room in order to insert and maneuver the tweezers 330. As such, the installation of the third FAU 315₃ is also easy. However, at this point, there is not enough room between the first FAU 315₁ and the third FAU 315₃ in order to insert another standard FAU 315 structure.

Referring now to FIG. 3C, a perspective view illustration of the electronic package 300 after a second FAU 315₂ is coupled to a second PIC 310 is shown, in accordance with an embodiment. In an embodiment, the second FAU 315₂ may have a T-shaped cross-section. For example, the second FAU 315₂ may be substantially similar to the FAUs 215 described in greater detail above. Due to the thin protrusion above the base, the tweezers can grip the protrusion in order to insert the second FAU 315₂ between the first FAU 315₁ and the third FAU 315₃. In an embodiment, a height of FAU 315₁ or 315₂ may be less than or equal to a height of the base of FAU 315₂. Accordingly, embodiments allow for reduced spacing between FAUs 315 (e.g., 100 μm or less) while still using the same tweezer 330 architecture. Additionally, it is to be appreciated that not all of the FAUs 315 need to have the T-shaped cross-section.

Referring now to FIG. 3D, a perspective view illustration of an electronic package 300 with a set of four FAUs 315₁-315₄ is shown, in accordance with an embodiment. In an embodiment, the order of placing the FAUs 315 is indicated by the number adjacent to each FAU 315. For example, as shown in FIG. 3D, a first FAU 315₁ is placed first, a third FAU 315₃ is placed second, a second FAU 315₂ is placed third, and a fourth FAU 315₄ is placed fourth. That is, the standard FAU structures (i.e., FAU 315₁ and FAU 315₃) are placed first with space between them, and the T-shaped FAU structures (i.e., FAU 315₂ and FAU 315₄) are place second. While FIG. 3D illustrates a generic example of the placement of the FAUs 315, it is to be appreciated that the individual FAUs may be placed in many different orders so long as the standard FAUs 315₁ and 315₃ are placed before the T-shaped cross-section FAUs 315₂ and 315₄. For example, the placement order may be FAU₃, FAU₁, FAU₄, FAU₂.

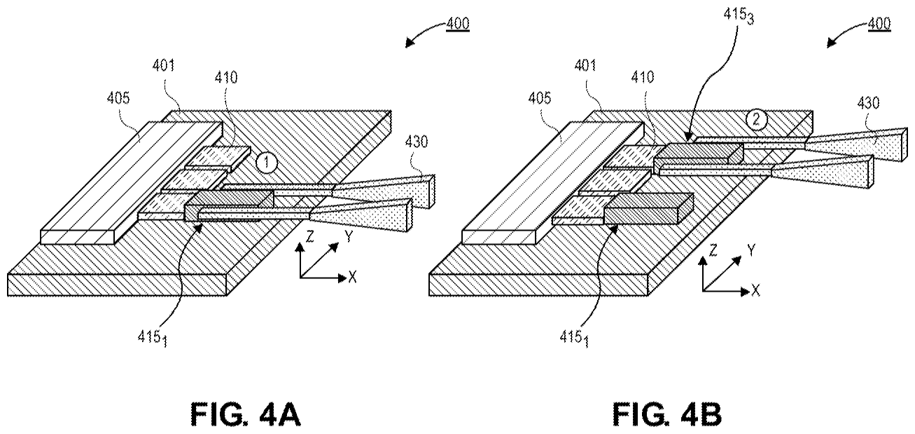

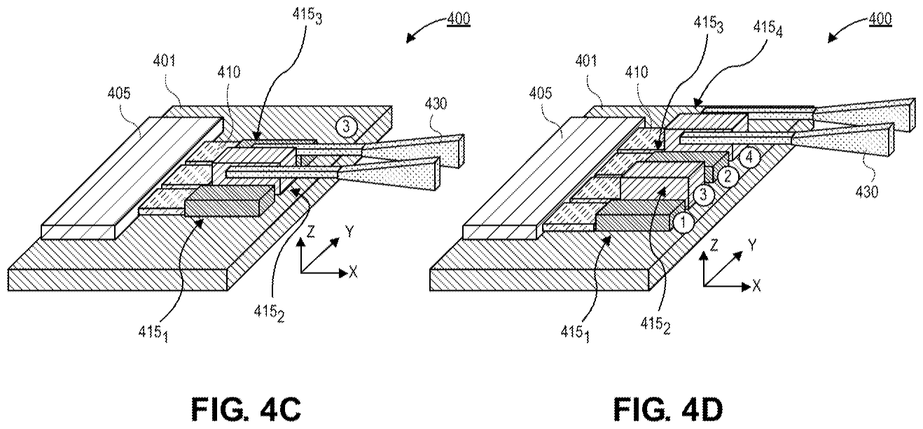

In the embodiments described in greater detail above, FAUs with T-shaped cross-sections are described. However, it is to be appreciated that embodiments do not require the specialized T-shaped structure in order to reduce the spacing between FAUs. In some instances, simply increasing the height of every other FAU will also enable small spacings between FAUs. That is, the short FAUs can be placed first, and the tall FAUs can be placed second. The extra height provides a location to grip the tall FAUs and maneuver them so that the tweezers remain above the top surface of the short FAUs. An example of such an embodiment is shown in FIGS. 4A-4D.

In FIG. 4A, the electronic package 400 comprises a package substrate 401, a die 405, and PICs 410. The package substrate 401, the die 405, and the PICs 410 may be similar to any of the embodiments described in greater detail above. As shown, tweezers 430 may couple a first FAU 415₁ to a first PIC 410. Since there are no other FAUs 415 in the way, the placement of the first FAU 415₁ is simple. The first FAU 415₁ may be a standard FAU structure. That is, the first FAU 415₁ may only include the base with no extending or protruding portions. The first FAU 415₁ may have a first height.

Referring now to FIG. 4B, a perspective view illustration of the electronic package 400 after a third FAU 415₃ is coupled to a third PIC 410 using tweezers 430 is shown, in accordance with an embodiment. In an embodiment, the third FAU 415₃ may also be a standard FAU 415 with the first height. Since the third FAU 415₃ and the first FAU 415₁ are separated by the middle PIC 410, there is still plenty of room in order to insert and maneuver the tweezers 430. As such, the installation of the third FAU 415₃ is also easy. However, at this point, there is not enough room between the first FAU 415₁ and the third FAU 415₃ in order to insert another standard FAU 415 structure.

Referring now to FIG. 4C, a perspective view illustration of the electronic package 400 after a second FAU 415₂ is coupled to a second PIC 410 is shown, in accordance with an embodiment. In an embodiment, the second FAU 415₂ may have a second height that is greater than the first height. The second height may be larger than the first height by a distance sufficient to accommodate the tweezers 430. That is, the second height may be equal to or greater than the first height plus the height of the tweezer arms. In a particular embodiment, the second height may be at least approximately twice the first height. Since the second height is greater than the first height, the tweezers can grip the upper portion of the second FAU 415₂ in order to insert the second FAU 415₂ between the first FAU 415₁ and the third FAU 415₃. Accordingly, embodiments allow for reduced spacing between FAUs 415 (e.g., 100 μm or less) while still using the same tweezer 430 architecture. Additionally, it is to be appreciated that not all of the FAUs 415 need to have the increased second height.

Referring now to FIG. 4D, a perspective view illustration of an electronic package 400 with a set of four FAUs 415₁-415₄ is shown, in accordance with an embodiment. In an embodiment, the order of placing the FAUs 415 is indicated by the number adjacent to each FAU 415. For example, as shown in FIG. 4D, a first FAU 415₁ is placed first, a third FAU 415₃ is placed second, a second FAU 415₂ is placed third, and a fourth FAU 415₄ is placed fourth. That is, the standard FAU structures (i.e., FAU 415₁ and FAU 415₃) are placed first with space between them, and the tall FAU structures (i.e., FAU 415₂ and FAU 415₄) are place second. While FIG. 4D illustrates a generic example of the placement of the FAUs 415, it is to be appreciated that the individual FAUs may be placed in many different orders so long as the standard FAUs 415₁ and 415₃ are placed before the tall FAUs 415₂ and 415₄. For example, the placement order may be FAU₃, FAU₁, FAU₄, FAU₂.

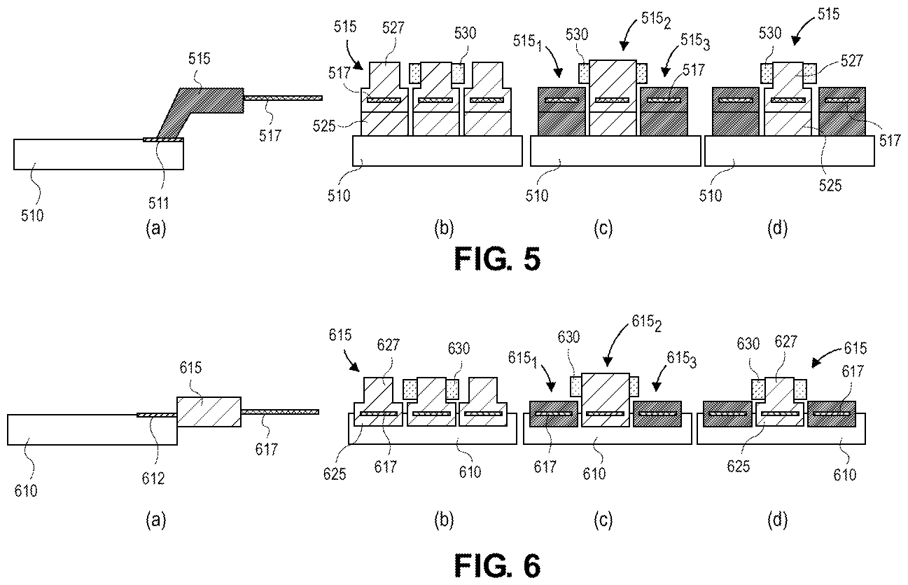

Referring now to FIG. 5, a series of cross-sectional illustrations showing the coupling between the PIC 510 and the FAU 515 is shown, in accordance with an embodiment. In the embodiment shown in FIG. 5, the coupling between the PIC 510 and the FAU 515 is implemented by a grating coupler 511, as shown in FIG. 5(a). In this way, the optical fibers 517 are coupled to the PIC 510 in a vertical arrangement. As shown in FIG. 5(b) (a side view of FIG. 5(a)), each of the FAUs 515 may include a T-shaped architecture with a base 525 and a protrusion 527. As such, the tweezers 530 can grip and position the FAUs 515 with minimal spacing between them. In FIG. 5(c), an example with a tall FAU 515₂ that is adjacent to a pair of short FAUs 515₁ and 515₃ is shown. In FIG. 5(d) an example with a T-shaped FAU 515 (with a base 525 and a protrusion 527) that is adjacent to standard FAUs 515 is shown.

Referring now to FIG. 6, a series of cross-sectional illustrations showing the coupling between the PIC 610 and the FAU 615 is shown, in accordance with an embodiment. In the embodiment shown in FIG. 6, the coupling between the PIC 610 and the FAU 615 is implemented by edge coupling to a waveguide 612 at a top of the PIC 610, as shown in FIG. 6(a). In this way, the optical fibers 617 are coupled to the PIC 610 in a lateral arrangement. As shown in FIG. 6(b) (a side view of FIG. 6(a)), each of the FAUs 615 may include a T-shaped architecture with a base 625 and a protrusion 627. As such, the tweezers 630 can grip and position the FAUs 615 with minimal spacing between them. In FIG. 6(c), an example with a tall FAU 6152 that is adjacent to a pair of short FAUs 6151 and 6153 is shown. In FIG. 6(d) an example with a T-shaped FAU 615 (with a base 625 and a protrusion 627) that is adjacent to standard FAUs 615 is shown.

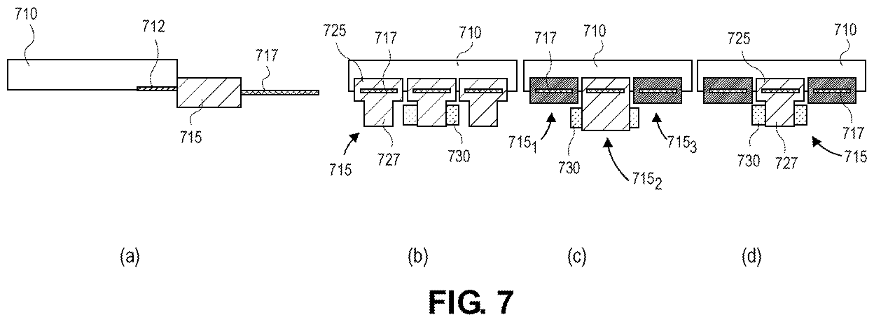

Referring now to FIG. 7, a series of cross-sectional illustrations showing the coupling between the PIC 710 and the FAU 715 is shown, in accordance with an embodiment. In the embodiment shown in FIG. 7, the coupling between the PIC 710 and the FAU 715 is implemented by edge coupling to a waveguide 712 at a bottom of the PIC 710, as shown in FIG. 7(a). In this way, the optical fibers 717 are coupled to the PIC 710 in a lateral arrangement. As shown in FIG. 7(b) (a side view of FIG. 7(a)), each of the FAUs 715 may include a T-shaped architecture with a base 725 and a protrusion 727. As such, the tweezers 730 can grip and position the FAUs 715 with minimal spacing between them. In FIG. 7(c), an example with a tall FAU 7152 that is adjacent to a pair of short FAUs 7151 and 7153 is shown. In FIG. 7(d) an example with a T-shaped FAU 715 (with a base 725 and a protrusion 727) that is adjacent to standard FAUs 715 is shown.

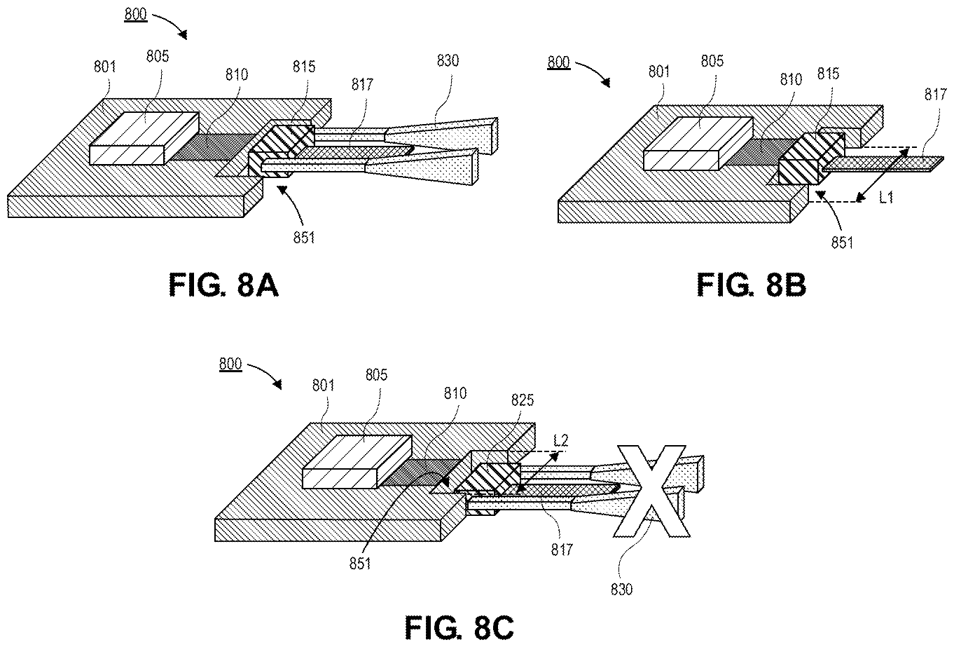

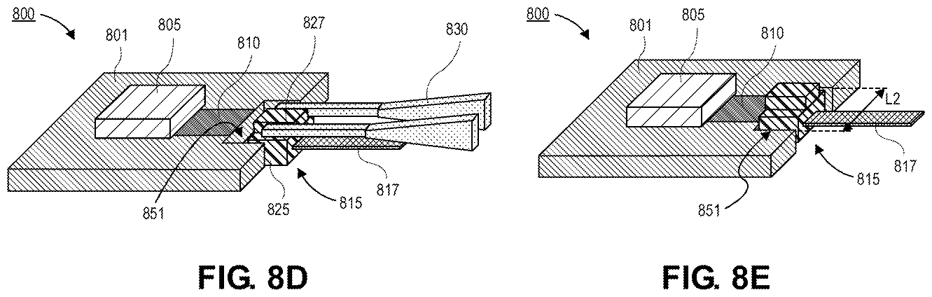

In some embodiments, it may be beneficial to insert the FAU into a cavity or cutout into the package substrate. However, taking space from the package substrate may result in less room for conductive routing. As such, it is desirable to minimize the size of the cutout. This is difficult with existing architectures, because room most be present to accommodate the tweezers for positioning the FAUs. An example of such a process is shown in FIGS. 8A-8C.

As shown in FIG. 8A, an electronic package 800 comprises a package substrate 801, a die 805, and a PIC 810. The package substrate 801, the die 805, and the PIC 810 may be substantially similar to similar structures described in greater detail above. In an embodiment, a cutout 851 is formed into the package substrate 801. An FAU 815 with optical fibers 817 may be inserted into the cutout 851 with tweezers 830. As shown in FIG. 8B, the tweezers 830 are retracted after the FAU 815 is secured to the PIC 810. In order to accommodate the tweezers 830, the cutout 851 may have a width L₁ that is equal to the width of the FAU 815 plus a margin for the tweezers 830.

However, when the cutout 851 is reduced in size, as shown in FIG. 8C, the tweezers 830 do not have enough room to insert the FAU 815. For example, when the width of the cutout 851 is reduced to L₂ (which is just slightly larger than the width of the FAU 815), there is no longer room for the tweezers 830.

Accordingly, embodiments disclosed herein may include FAUs 815 that include T-shaped cross-sections. For example, FIG. 8D illustrates the insertion of a T-shaped cross-section FAU 815 into the cutout 851 with tweezers 830. The FAU 815 may include a base 825 and a protrusion 827. The protrusion 827 is narrower than the base 825 and allows for the tweezers 830 to maneuver the FAU 815 even within a smaller cutout 851. For example, as shown in FIG. 8E, the cutout 851 may have a width L₂ that is only slightly larger than the width of the base 825. For example, the cutout 851 may be up to approximately 100 μm larger than the width of the base 825 in some embodiments.

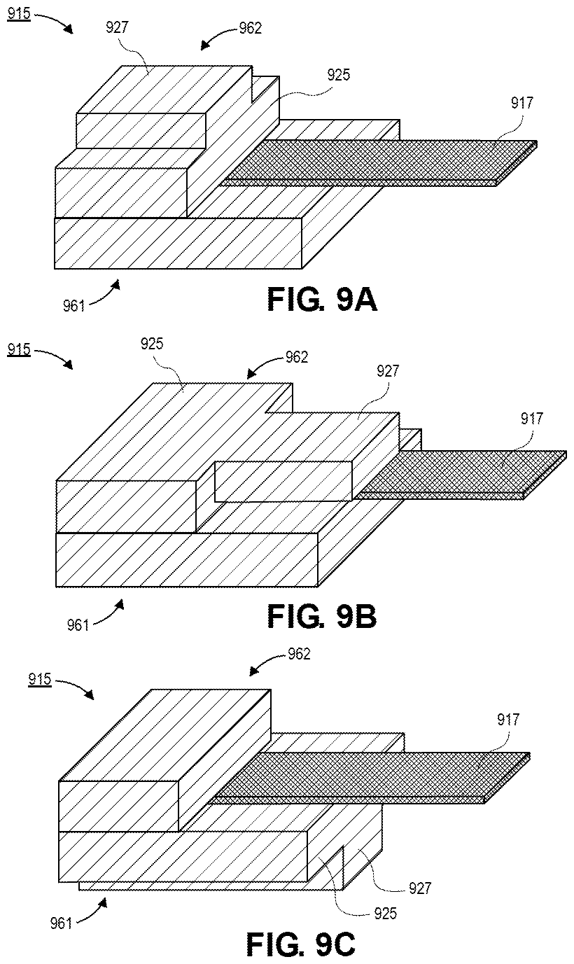

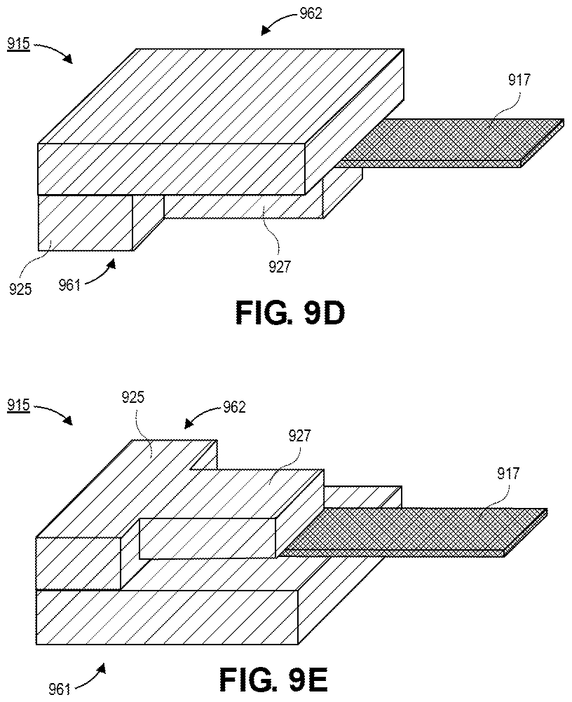

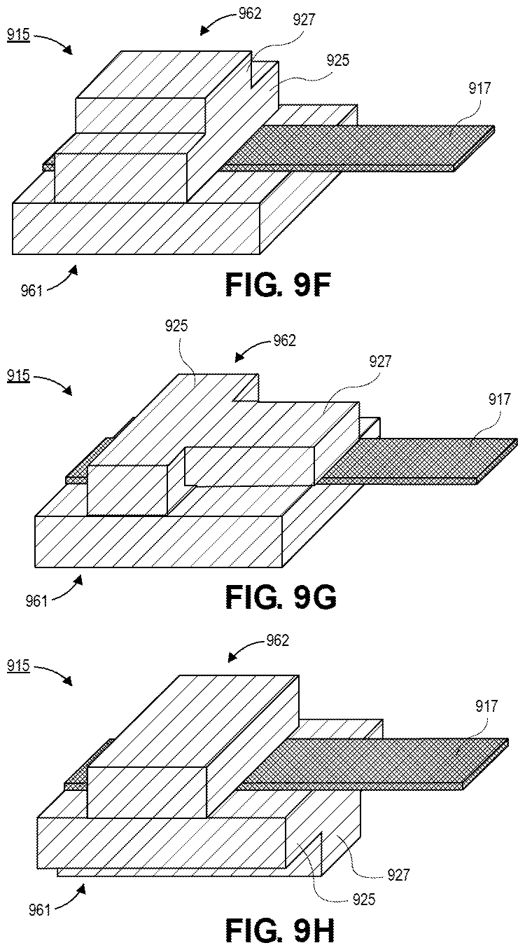

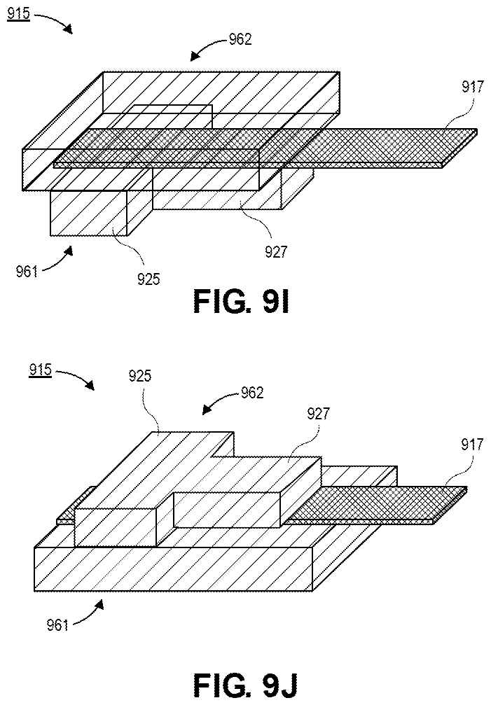

Referring now to FIGS. 9A-9J, a series of illustrations depicting more detailed constructions of the FAU 915 is shown, in accordance with an embodiment. As will be shown, the FAU 915 may include a base plate, a cover plate, and optical fibers between the baseplate and the cover plate. The FAU 915 may include T-shaped cross-sections in either the base plate or the cover plate. Additionally, the plane of the T-shaped cross-section may either be orthogonal to the direction of the optical fibers or parallel to the direction of the optical fibers.

Referring now to FIG. 9A, a perspective view illustration of an FAU 915 is shown, in accordance with an embodiment. In an embodiment, the FAU 915 comprises a base plate 961 and a cover plate 962. Optical fibers 917 are provided between the base plate 961 and the cover plate 962. For example, V-grooves (not shown) may be provided in the base plate 961, and the optical fibers 917 may rest in the V-grooves between the base plate 961 and the cover plate 962.

In the illustrated embodiment, the T-shaped cross-section is provided in the cover plate 962. For example, the cover plate 962 may comprise a base 925 and a protrusion 927. The protrusion 927 may have a width that is narrower than a width of the base 925. In an embodiment the plane of the T-shaped cross-section is orthogonal to a direction of the optical fibers 917.

Referring now to FIG. 9B, a perspective view illustration of an FAU 915 is shown, in accordance with an additional embodiment. Instead of having the T-shaped cross-section orthogonal to the direction of the optical fibers 917, the plane of the T-shaped cross-section is parallel to the direction of the optical fibers 917. That is, the T-shaped cross-section lies flat over the top surface of the base plate 961.

Referring now to FIG. 9C, a perspective view illustration of an FAU 915 is shown, in accordance with an additional embodiment. In the illustrated embodiment, the T-shaped cross-section is provided in the base plate 961. For example, the base plate 961 may comprise a base 925 and a protrusion 927. In an embodiment, the plane of the T-shaped cross-section is orthogonal to a direction of the optical fibers 917.

Referring now to FIG. 9D, a perspective view illustration of an FAU 915 is shown, in accordance with an additional embodiment. Instead of having the T-shaped cross-section orthogonal to the direction of the optical fibers 917, the plane of the T-shaped cross-section is parallel to a direction of the optical fibers 917. The T-shaped cross-section may be provided in the base plate 961 below the optical fibers 917.

Referring now to FIG. 9E, a perspective view illustration of an FAU 915 is shown, in accordance with an additional embodiment. The FAU 915 in FIG. 9E may be substantially similar to the FAU 915 in FIG. 9B, with the exception of the length of the protrusion 927. Instead of extending to an edge of the base plate 961, the protrusion 927 stops short of the edge. This exposes a portion of the optical fibers 917 over the base plate 961.

Referring now to FIG. 9F, a perspective view illustration of an FAU 915 is shown, in accordance with an additional embodiment. The FAU 915 in FIG. 9F may be substantially similar to the FAU 915 in FIG. 9A, with the exception of the position of cover plate 962. Instead of being aligned with an edge of the base plate 961, the cover plate 962 is moved off of the edge of the base plate 961. This exposes a portion of the optical fibers 917 on both sides of the cover plate 962.

Referring now to FIG. 9G, a perspective view illustration of an FAU 915 is shown, in accordance with an additional embodiment. The FAU 915 in FIG. 9E may be substantially similar to the FAU 915 in FIG. 9B, with the exception of the position of the edge of the base 925. Instead of being aligned with an edge of the base plate 961, the base 925 stops short of the edge. This exposes a portion of the optical fibers 917 over the base plate 961.

Referring now to FIG. 9H, a perspective view illustration of an FAU 915 is shown, in accordance with an additional embodiment. The FAU 915 in FIG. 9H may be substantially similar to the FAU 915 in FIG. 9C, with the exception of the positioning of the cover plate 962. Instead of being aligned with an edge of the base plate 961, the cover plate 962 is moved away from the edge of the base plate 961. That is, optical fibers 917 are exposed on both sides of the cover plate 962.

Referring now To FIG. 9I, a perspective view illustration of an FAU 915 is shown, in accordance with an additional embodiment. The FAU 915 in FIG. 9I may be substantially similar to the FAU 915 in FIG. 9C, with the exception of the cover plate 962 covering the entire face of the base plate 961. That is, there are no portions of the optical fibers 917 exposed over the base plate 961.

Referring now to FIG. 9J, a perspective view illustration of an FAU 915 is shown, in accordance with an additional embodiment. The FAU 915 in FIG. 9J may be substantially similar to the FAU 915 in FIG. 9B, with the exception of the length of the cover plate 962. Instead of extending to an edge of the base plate 961, the cover plate 962 is set back from both edges of the base plate 961. As such, optical fibers 917 are exposed to the left and the right of the cover plate 962.

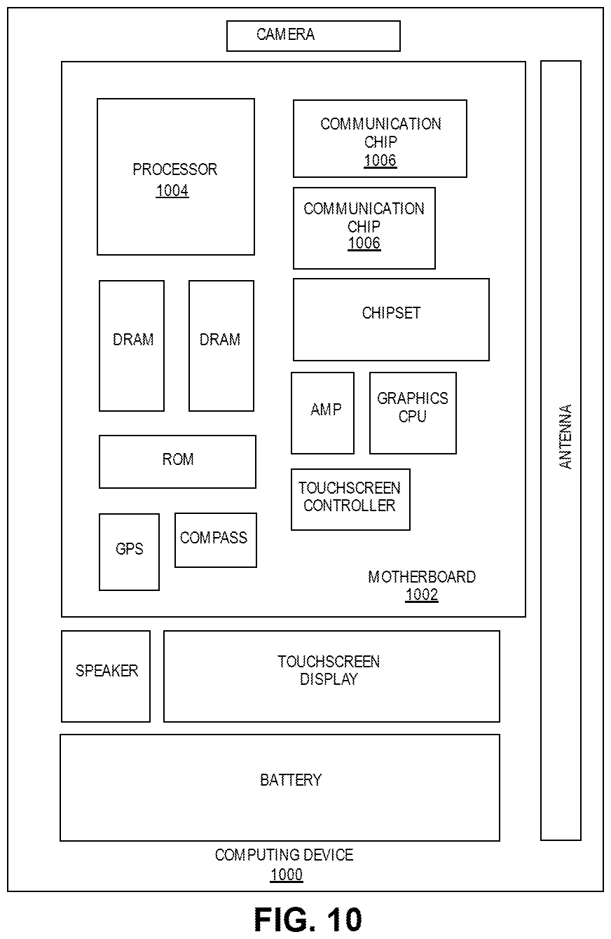

FIG. 10 illustrates a computing device 1000 in accordance with one implementation of the invention. The computing device 1000 houses a board 1002. The board 1002 may include a number of components, including but not limited to a processor 1004 and at least one communication chip 1006. The processor 1004 is physically and electrically coupled to the board 1002. In some implementations the at least one communication chip 1006 is also physically and electrically coupled to the board 1002. In further implementations, the communication chip 1006 is part of the processor 1004.

These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth).

The communication chip 1006 enables wireless communications for the transfer of data to and from the computing device 1000. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 1006 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 1000 may include a plurality of communication chips 1006. For instance, a first communication chip 1006 may be dedicated to shorter range wireless communications such as Wi-Fi and Bluetooth and a second communication chip 1006 may be dedicated to longer range wireless communications such as GPS, EDGE, GPRS, CDMA, WiMAX, LTE, Ev-DO, and others.

The processor 1004 of the computing device 1000 includes an integrated circuit die packaged within the processor 1004. In some implementations of the invention, the integrated circuit die of the processor may be part of an electronic system that includes an FAU with a T-shaped cross-section, in accordance with embodiments described herein. The term “processor” may refer to any device or portion of a device that processes electronic data from registers and/or memory to transform that electronic data into other electronic data that may be stored in registers and/or memory.

The communication chip 1006 also includes an integrated circuit die packaged within the communication chip 1006. In accordance with another implementation of the invention, the integrated circuit die of the communication chip may be part of an electronic system that includes an FAU with a T-shaped cross-section, in accordance with embodiments described herein.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

These modifications may be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

Example 1: an electronic package, comprising: a package substrate; a die coupled to the package substrate; a photonics integrated circuit (PIC) coupled to the die; and a fiber array unit (FAU) optically coupled to the PIC, wherein the FAU has a base with a first width and a protrusion with a second width that is smaller than the first width.

Example 2: the electronic package of Example 1, further comprising: a plurality of PICs coupled to the die; and a plurality of FAUs, wherein each FAU is coupled to a different one of the plurality of PICs.

Example 3: the electronic package of Example 2, wherein each of the plurality of FAUs comprise the base and the protrusion.

Example 4: the electronic package of Example 2 or Example 3, wherein the FAU and a third FAU are separated by a second FAU, wherein the third FAU comprises the base and the protrusion.

Example 5: the electronic package of Example 4, wherein the second FAU has a height that is equal to or less than a height of the base.

Example 6: the electronic package of Examples 2-5, wherein a gap between individual FAUs in the plurality of FAUs is approximately 100 μm or less.

Example 7: the electronic package of Examples 1-6, wherein the base has a height that is greater than a height of the PIC.

Example 8: the electronic package of Examples 1-7, further comprising: a cutout in the package substrate, wherein the FAU passes at least partially through the cutout.

Example 9: the electronic package of Example 8, wherein a width of the cutout is up to approximately 100 μm more than the first width.

Example 10: the electronic package of Examples 1-9, wherein the FAU is optically coupled to the PIC by a grating coupler.

Example 11: the electronic package of Examples 1-10, wherein the FAU is optically coupled to the PIC by edge coupling at a bottom or a top of the PIC.

Example 12: an electronic package, comprising: a package substrate; a die coupled to the package substrate; a set of three or more photonics integrated circuits (PICs) coupled to the die; and a set of three or more fiber array units (FAUs) coupled to the set of three or more PICs, wherein a first FAU has a first height, a second FAU has a second height that is greater than the first height, and a third FAU that has the first height, and wherein the second FAU is between the first FAU and the second FAU.

Example 13: the electronic package of Example 12, wherein the set of three or more FAUs further comprises a fourth FAU with the second height, wherein the third FAU separates the second FAU from the fourth FAU.

Example 14: the electronic package of Examples 12-13, wherein the second FAU has a T-shaped cross-section.

Example 15: the electronic package of Examples 12-14, wherein a space between the first FAU and the second FAU is approximately 100 μm or less.

Example 16: the electronic package of Examples 12-15, wherein the second height is at least twice as large as the first height.

Example 17: a method of assembling an electronic package, comprising: providing a die and a plurality of photonics integrated circuits (PICs) on a package substrate; coupling a first fiber array unit (FAU) to a first PIC, wherein the first FAU has a first height; coupling a third FAU to a third PIC, wherein the third FAU has the first height; and coupling a second FAU to a second PIC, wherein the second FAU has a second height that is greater than the first height, and wherein the second FAU is between the first FAU and the third FAU.

Example 18: the method of Example 17, wherein the first FAU and the third FAU are coupled to first PIC and the second PIC before the second FAU is coupled to the second PIC.

Example 19: the method of Examples 17-18, wherein the second FAU comprises a base and a protrusion, wherein the protrusion has a width that is smaller than a width of the base.

Example 20: the method of Examples 17-19, wherein the first height is half the second height or less.

Example 21: the method of Examples 17-20, further comprising: coupling a fourth FAU to a fourth PIC, wherein the fourth FAU has the second height and wherein the fourth FAU is separated from the second FAU by the third FAU.

Example 22: the method of Examples 17-21, wherein the third FAU is coupled to the third PIC before the first FAU is coupled to the first PIC.

Example 23: a fiber array unit (FAU), comprising: a base plate with a plurality of V-grooves on a surface of the base plate; a plurality of optical fibers provided in the plurality of V-grooves; and a cover plate over the plurality of optical fibers and the base plate, wherein the base plate or the cover plate comprises a T-shaped cross-section.

Example 24: the FAU of Example 23, wherein a plane of the T-shaped cross-section is perpendicular to a direction of the plurality of optical fibers.

Example 25: the FAU of Example 23, wherein a plane of the T-shaped cross-section is parallel to a direction of the plurality of optical fibers.

What is claimed is:

1. An electronic package, comprising:
a package substrate;
a die coupled to the package substrate;
a photonics integrated circuit (PIC) coupled to the die; and
a fiber array unit (FAU) optically coupled to the PIC, wherein the FAU has a base with a first width and a protrusion with a second width that is smaller than the first width.

2. The electronic package of claim 1, further comprising:
a plurality of PICs coupled to the die; and
a plurality of FAUs, wherein each FAU is coupled to a different one of the plurality of PICs.

3. The electronic package of claim 2, wherein each of the plurality of FAUs comprise the base and the protrusion.

4. The electronic package of claim 2, wherein the FAU and a third FAU are separated by a second FAU, wherein the third FAU comprises the base and the protrusion.

5. The electronic package of claim 4, wherein the second FAU has a height that is equal to or less than a height of the base.

6. The electronic package of claim 2, wherein a gap between individual FAUs in the plurality of FAUs is approximately 100 μm or less.

7. The electronic package of claim 1, wherein the base has a height that is greater than a height of the PIC.

8. The electronic package of claim 1, further comprising:
a cutout in the package substrate, wherein the FAU passes at least partially through the cutout.

9. The electronic package of claim 8, wherein a width of the cutout is up to approximately 100 μm more than the first width.

10. The electronic package of claim 1, wherein the FAU is optically coupled to the PIC by a grating coupler.

11. The electronic package of claim 1, wherein the FAU is optically coupled to the PIC by edge coupling at a bottom or a top of the PIC.

12. An electronic package, comprising:
a package substrate;
a die coupled to the package substrate;
a set of three or more photonics integrated circuits (PICs) coupled to the die; and
a set of three or more fiber array units (FAUs) coupled to the set of three or more PICs, wherein a first FAU has a first height, a second FAU has a second height that is greater than the first height, and a third FAU that has the first height, and wherein the second FAU is between the first FAU and the second FAU.

13. The electronic package of claim 12, wherein the set of three or more FAUs further comprises a fourth FAU with the second height, wherein the third FAU separates the second FAU from the fourth FAU.

14. The electronic package of claim 12, wherein the second FAU has a T-shaped cross-section.

15. The electronic package of claim 12, wherein a space between the first FAU and the second FAU is approximately 100 μm or less.

16. The electronic package of claim 12, wherein the second height is at least twice as large as the first height.

17. A method of assembling an electronic package, comprising:
providing a die and a plurality of photonics integrated circuits (PICs) on a package substrate;
coupling a first fiber array unit (FAU) to a first PIC, wherein the first FAU has a first height;
coupling a third FAU to a third PIC, wherein the third FAU has the first height; and
coupling a second FAU to a second PIC, wherein the second FAU has a second height that is greater than the first height, and wherein the second FAU is between the first FAU and the third FAU.

18. The method of claim 17, wherein the first FAU and the third FAU are coupled to first PIC and the second PIC before the second FAU is coupled to the second PIC.

19. The method of claim 17, wherein the second FAU comprises a base and a protrusion, wherein the protrusion has a width that is smaller than a width of the base.

20. The method of claim 17, wherein the first height is half the second height or less.

21. The method of claim 17, further comprising:
coupling a fourth FAU to a fourth PIC, wherein the fourth FAU has the second height and wherein the fourth FAU is separated from the second FAU by the third FAU.

22. The method of claim 17, wherein the third FAU is coupled to the third PIC before the first FAU is coupled to the first PIC.

23. A fiber array unit (FAU), comprising:
a base plate with a plurality of V-grooves on a surface of the base plate;
a plurality of optical fibers provided in the plurality of V-grooves; and
a cover plate over the plurality of optical fibers and the base plate, wherein the base plate or the cover plate comprises a T-shaped cross-section.

24. The FAU of claim 23, wherein a plane of the T-shaped cross-section is perpendicular to a direction of the plurality of optical fibers.

25. The FAU of claim 23, wherein a plane of the T-shaped cross-section is parallel to a direction of the plurality of optical fibers.
